(19) United States
(12) Patent Application Publication
(10) Pub. No.: US 2020/0293001 A1
(43) Pub. Date: Sep. 17, 2020

(54) CERAMIC-BASED TIMEPIECE OR JEWELLERY COMPONENT WITH A STRUCTURED DECORATION

(71) Applicant: Omega SA, Biel/Bienne (CH)

(72) Inventors: Frederic Jeanrenaud, La Chaux-de-Fonds (CH); Gregory Kissling, La Neuveville (CH)

(73) Assignee: Omega SA, Biel/Bienne (CH)

(21) Appl. No.: 16/813,806

(22) Filed: Mar. 10, 2020

(30) Foreign Application Priority Data
Mar. 14, 2019 (EP) 19162936.9

(51) Int. Cl. G04D 3/00; G04B 19/10; G04B 45/00

(52) U.S. Cl. CPC G04D 3/0048; G04D 3/0092; G04B 45/00; G04B 19/10

(57) ABSTRACT

A method for fabricating a timepiece or jewellery component with a structured decoration: a ceramic base is made; mirror polishing is performed; laser and/or mechanical machining of a surface relief is carried out; a relief is coated with a first layer of a first metal decorative treatment and/or coloured decorative treatment material; prior to or after the coating, deep etching is performed to produce a first hollow decoration having a depth greater than the thickness of the first layer, penetrating the base beneath its apparent surface and beneath the valleys of the relief; laser ablation is performed on the first layer in pockets at the bottom of which the ceramic is revealed; all the visible surfaces of the component are coated with a second layer of a second material.

### FIELD OF THE INVENTION

The invention concerns a method for fabricating a ceramic-based timepiece or jewellery component with a structured decoration.

The invention also concerns a watch including an external element and/or a dial made by this method.

The invention concerns the field of external or display components for horology, and the field of jewellery.

### BACKGROUND OF THE INVENTION

For the fabrication of decorated components, it is difficult to achieve optical effects properly, especially when the decoration is affixed tone-on-tone, and the mechanical structuring of a decoration changes the light diffraction and appearance of the decoration.

EP Patent Application No. 3067220 in the name of ROLEX discloses a method for decorating a timepiece element, comprising the steps of deep etching a surface of the element to be decorated using a femtosecond laser, and surface structuring the surface of the timepiece element to be decorated, these two decorations being at least partially superposed on one another.

CH Patent No. 713871 in the name of RICHEMONT discloses a component for timepieces having a plurality of graphic elements and the method for fabricating the same, the component comprising a substrate, at least one portion of which is coated with a coating having a plurality of layers, including an outer layer and at least one intermediate layer formed between the substrate and the outer layer, the intermediate layer having a different appearance from that of the outer layer; the coating comprising at least a first opening defining a first graphic element, the first opening having a first depth that reveals the intermediate layer; and a second opening defining a second graphic element, the second opening having a second depth, different from the first depth; such that the component has at least two graphic elements having a different appearance from one another.

### SUMMARY OF THE INVENTION

The invention proposes to develop a method for creating decorative effects and shades, or holographic effects, and in particular for tone-on-tone.

To this end, the invention concerns a method for fabricating a ceramic-based timepiece or jewellery component with a structured decoration according to claim 1.

The invention also concerns a watch including an external element and/or a dial made by this method.

The invention also concerns a piece of jewellery including at least one jewellery component made by the method according to the invention.

The proposed mode of operation makes it possible to obtain high definition decorations on substrates, such as ceramic, but also sapphire, glass or similar.

### BRIEF DESCRIPTION OF THE DRAWINGS

Other features and advantages of the invention will appear upon reading the following detailed description, with reference to the annexed drawings, in which:

FIGS. 1 to 11 represent schematic sectional views of the operating sequences of a method according to the invention:

FIG. 1 represents the making of a base;

FIG. 2 represents the mirror polishing of each apparent surface of the base intended to be seen by the user;

FIG. 3 represents a first machining operation wherein laser machining and/or mechanical machining with a diamond tool and/or abrasive machining is performed to produce a first fine-pattern etch of at least some structured surfaces comprising a surface relief extending between peaks and valleys;

FIG. 4 represents a first transfer operation of affixing and bonding at least one decorative element on a first external surface of the first layer;

FIG. 5 represents a first coating operation wherein at least one portion of the surface relief is coated with a first thickness of at least a first layer of a first metal decorative treatment and/or coloured decorative treatment material, and which is followed, in FIG. 6, by a second machining operation during which deep etching is performed to produce a first hollow decoration with a depth greater than the first thickness and penetrating the base beneath the apparent surface and beneath the valleys of the surface relief;

FIGS. 6 and 7 represent the operations of FIGS. 4 and 5 performed in reverse order: FIG. 6 represents a second machining operation during which deep etching is performed to produce a first hollow decoration with a depth greater than the first thickness and penetrating the base beneath the apparent surface and beneath the valleys of the surface relief, and which is followed by the operation of FIG. 7, wherein at least one portion of the surface relief is coated with a first thickness of at least a first layer of a first metal decorative treatment and/or coloured decorative treatment material;

FIG. 8 represents a third machining operation applied to the blank produced in FIGS. 4 and 5, and wherein laser ablation is performed on the first layer in pockets at the bottom of which the ceramic material of the base is revealed;

FIG. 9 represents, in a similar manner to FIG. 8, a third machining operation applied to the blank produced in FIGS. 6 and 7;

FIG. 10 represents a second coating operation, applied to the blank of FIG. 8, and wherein all the visible surfaces of the component are coated with a deposition of a second layer of a second treatment material;

FIG. 11 shows, in a similar manner to FIG. 10, a second coating operation, applied to the blank of FIG. 9;

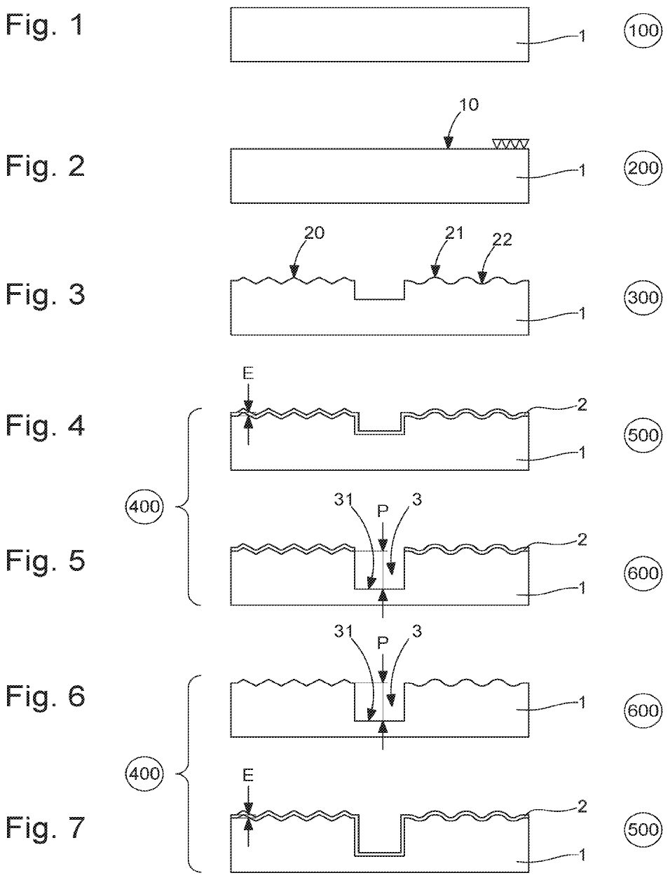

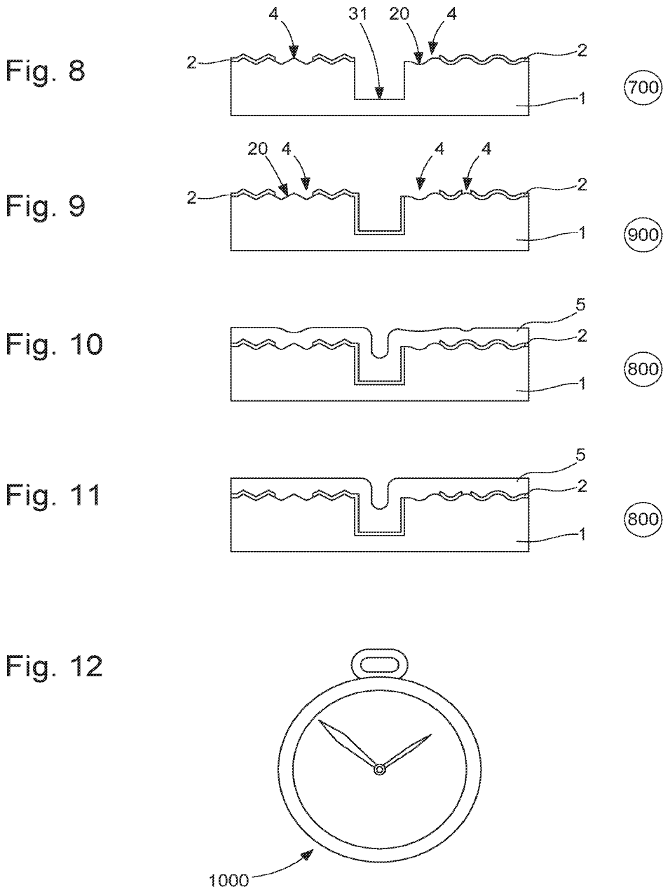

and FIG. 12 represents a watch including a dial made and decorated by the method of the invention.

### DETAILED DESCRIPTION OF PREFERRED EMBODIMENTS

The invention concerns a method for fabricating a ceramic-based timepiece or jewellery component with a structured decoration, wherein a basic cycle is performed at least once, including, in this order, the following steps:

in an initial operation 100, making a base 1 from a substrate made of ceramic material;
in a first polishing operation 200, mirror polishing base 1, at least on apparent surfaces 10 intended to be seen by the user;
in a second machining operation 300 performing laser machining and/or mechanical machining with a diamond tool and/or abrasive machining to produce a first fine-pattern etch of at least some structured surfaces having a surface relief 20 extending between peaks 21 and valleys 22, or a Guilloché, or sunray, or chased, or engraved, or perlage, or snailed, or circular grained, or anglage, or satin, or drawn, or concave chamfered finish, or Côtes de Genève, or Clous de Paris;
in a first preparation operation 400, performing a first coating operation 500 wherein at least one portion of surface relief 20 is coated with a first thickness E of at least a first layer 2 of a first metal decorative treatment and/or coloured decorative treatment material, and performing, prior to or after first coating operation 500, a second machining operation 600 during which deep etching is performed to produce a first hollow decoration 3 with a depth P greater than first thickness E and penetrating base 1 beneath apparent surface 10 and beneath the valleys 22 of the surface relief;
in a third machining operation 700, performing laser ablation on first layer 2 in pockets 4 at the bottom of which the ceramic material of base 1 is revealed. In fact, laser machining makes it possible to remove a surface layer, however thin it maybe, to reach the surface of a base substrate, without damaging the latter.

According to a particular feature, during first preparation operation 400, first coating operation 500 is performed prior to second machining operation 600, as seen in FIGS. 4 and 5.

According to another particular feature, during first preparation operation 400, second machining operation 600 is performed prior to first coating operation 500, as seen in FIGS. 6 and 7.

According to a particular feature, during third machining operation 700, the machining of at least one pocket 4 in the ceramic material of base 1 is continued.

According to the invention, after third machining operation 700, a second coating operation 800 is performed wherein all of the visible surfaces of the component are coated with a deposition of a second layer 5 of a second treatment material.

More particularly, after second coating operation 800, in a fourth machining operation 900, laser ablation is performed on second layer 5 in pockets at the bottom of which the ceramic material of base 1 and/or the first treatment material of first layer 2 is revealed.

According to a particular feature, after fourth machining operation 700, an iteration is carried out wherein each time a coating operation is performed in which all of the surfaces left visible by the preceding operation are coated, and with a deposition of another layer of another treatment material, then laser ablation is performed on the new layer in pockets at the bottom of which the ceramic material of the base and/or the first treatment material of the first layer, or the material of one of the layers which are underneath the new layer, is revealed.

According to a particular feature, after the last machining operation, a last coating operation is performed wherein all of the visible surfaces of the component are coated with a transparent deposition of a transparent treatment material 5 in a dry process or in a PVD or CVD or ALD process, or lacquering or zapon varnish process.

According to a particular feature, after the last machining operation, a last operation is performed wherein a semi-transparent colouring treatment is performed on the visible surfaces of the component with a coloured transparent deposition in a dry process or in a PVD or CVD or ALD process or lacquering or zapon varnish process.

According to a particular feature, first layer 2 is chosen to have the same colour as the ceramic material of the base.

According to a particular feature, first layer 2 is chosen to have a higher density of coloured pigments than that of the ceramic material of the base.

According to a particular feature, all the superposed layers comprised in the component are chosen to have the same colour as the ceramic material of the base.

According to a particular feature, each of the superposed layers comprised in the component are chosen to have a higher density of coloured pigments than that of the layer that they coat, and higher than that of the ceramic material of the base.

In a variant, the reverse is true, with a density of coloured pigments that decreases from the base to the outermost layer.

According to a particular feature, a black or dark grey colour is chosen.

According to a particular feature, the timepiece or jewellery component is made to form an external element or a dial.

The invention also concerns a watch 1000 comprising at least one timepiece or jewellery component made by the method according to the invention.

The invention also concerns a piece of jewellery including at least one jewellery component made by the method according to the invention.

Naturally, the invention is advantageous, not only for parts of timepiece components, but also for jewellery or jewellery components, or spectacles or fashion items.

Indeed, the invention makes it possible to change and substantially enhance the appearance of components directly visible to the user, with innovative decorations, and contributes to the promotion of the brand and product. More particularly, the invention can be used for identification marking and/or anti-counterfeit marking.

1. A method for fabricating a ceramic-based timepiece or jewellery component with a structured decoration, wherein a basic cycle is performed at least once, comprising, in order, the following steps:
in an initial operation, making a base from a substrate made of ceramic material;
in a first polishing operation, mirror polishing said base, at least on apparent surfaces intended to be seen by the user;
in a second machining operation performing laser machining and/or mechanical machining with a diamond tool and/or abrasive machining to produce a first fine-pattern etch of at least some structured surfaces having a surface relief extending between peaks and valleys, or a Guilloché, or sunray, or chased, or engraved, or perlage, or snailed, or circular grained, or anglage, or satin, or drawn, or concave chamfered finish, or Côtes de Genève, or Clous de Paris;
in a first preparation operation, performing a first coating operation wherein at least one portion of said surface relief is coated with a first thickness E of at least a first layer of a first metal decorative treatment and/or coloured decorative treatment material, and performing, prior to or after said first coating operation, a second machining operation during which deep etching is performed to produce a first hollow decoration with a depth P greater than said first thickness E and penetrating said base beneath said apparent surface and beneath said valleys of said surface relief;
in a third machining operation, performing laser ablation on said first layer in pockets at the bottom of which the ceramic material of said base is revealed;
after said third machining operation a second coating operation is performed wherein all of the visible surfaces of said component are coated with a deposition of a second layer of a second treatment material.

2. The method according to claim 1, wherein, during said first preparation operation said first coating operation is performed before said second machining operation.

3. The method according to claim 1, wherein, during said first preparation operation said second machining operation is performed before said second coating operation.

4. The method according to claim 1, wherein, during said third machining operation, the machining of at least one said pocket is continued in the ceramic material of said base.

5. The method according to claim 1, wherein, after said second coating operation, in a fourth machining operation, laser ablation is performed on said second layer in pockets at the bottom of which the ceramic material of said base, or the first treatment material of said first layer, is revealed.

6. The method according to claim 5, wherein, after said fourth machining operation, an iteration is carried out wherein each time a coating operation is performed wherein all of the surfaces left visible by the preceding operation are coated with a deposition of another layer of another treatment material, then laser ablation is performed on the new layer in pockets at the bottom of which the ceramic material of said base, or the first treatment material of said first layer, or the material of one of the layers which are underneath said new layer, is revealed.

7. The method according to claim 1, wherein, after the last machining operation, a last coating operation is performed wherein all of the visible surfaces of said component are coated with a transparent deposition of a transparent treatment material in a dry process or in a PVD or CVD or ALD process, or lacquering or zapon varnish process.

8. The method according to claim 1, wherein, after the last machining operation, a last operation is performed wherein a semi-transparent colouring treatment is performed on the visible surfaces of said component with a coloured transparent deposition in a dry process or in a PVD or CVD or ALD process or lacquering or zapon varnish process.

9. The method according to claim 1, wherein said first layer is chosen to have the same colour as said ceramic material of said base.

10. The method according to claim 9, wherein said first layer is chosen to have a higher density of coloured pigments than that of said ceramic material of said base.

11. The method according to claim 1, wherein all the superposed layers comprised in said component are chosen to have the same colour as said ceramic material of said base.

12. The method according to claim 11, wherein each of the superposed layers comprised in said component are chosen to have a higher density of coloured pigments than that of the layer that said superposed layers coat, and higher than that of said ceramic material of said base.

13. The method according to claim 9, wherein said colour is chosen to be black or dark grey.

14. The method according to claim 11, wherein said colour is chosen to be black or dark grey.

15. The method according to claim 1, wherein said timepiece or jewellery component is made to form an external element or a dial.

16. A watch comprising at least one component for horology or jewellery made by the method according to claim 1.
